(19) United States
(12) Patent Application Publication
(10) Pub. No.: US 2012/0010329 A1
(43) Pub. Date: Jan. 12, 2012

(54) CURABLE EPOXY RESIN COMPOSITIONS AND CURED PRODUCTS THEREFROM

(76) Inventors: Gary A. Hunter, Laka Jackson, TX (US); Ha Q. Pham, Lake Jackson, TX (US); George Jacob, Lake Jackson, TX (US); Rajesh Turakhia, Lake Jackson, TX (US)

(21) Appl. No.: 13/145,378

(22) PCT Filed: Feb. 8, 2010
(86) PCT No.: PCT/US10/23432

§ 371 Date: Jul. 20, 2011

Related U.S. Application Data
(60) Provisional application No. 61/154,846, filed on Feb. 24, 2009.

(51) Int. Cl. C09J 163/02; C08K 3/40; B05D 3/02; B05D 7/00; B05D 3/00; C08G 59/56; C08K 3/26

(52) U.S. Cl. 523/457; 528/93; 523/466; 427/386; 427/379

(57) ABSTRACT

Curable epoxy resin compositions, cured epoxy resin compositions, and processes of forming the same, including at least one epoxy resin, at least one sterically hindered amine curing agent and at least one non-sterically hindered amine curing agent which provides toughness properties to the curable composition and resultant cured product made from the curable composition.

### FIELD OF THE INVENTION

Embodiments of the present invention disclosed herein relate generally to epoxy resins and epoxy resin compositions. More specifically, embodiments of the present invention disclosed herein relate to curable compositions and cured compositions including an epoxy resin, sterically hindered amines and aliphatic amines. The combination of sterically hindered amines, and non-sterically hindered amines are used to enhance fracture toughness of amine cured epoxy thermoset resins via an interpenetrating network.

### BACKGROUND OF THE INVENTION

Epoxy thermoset resins are one of the most widely used engineering resins, and are well-known for their use in adhesives, coatings and composites. Epoxy resins form a glassy network, exhibit excellent resistance to corrosion and solvents, good adhesion, reasonably high glass transition temperatures, and adequate electrical properties. Unfortunately, crosslinked, glassy epoxy resins with relatively high glass transition temperatures (>100° C.) are brittle. The poor impact strength of high glass transition temperature epoxy resins limits their usage in some applications.

The impact strength, fracture toughness, ductility, as well as most other physical properties of crosslinked epoxy resins is controlled by the chemical structure and ratio of the epoxy resin and hardener, by any added macroscopic fillers, toughening agents, and other additives, and by the curing conditions used. For example, rubber toughening agents have been added to epoxies to improve ductility, with a corresponding decrease in stiffness, as described for example, in Ratna et al., “Rubber Toughened Epoxy,” Macromolecular Research, 2004, 12(1), pages 11-21.

Toughening agents used to improve fracture toughness of epoxies include linear polybutadiene-polyacrylonitrile copolymers, oligomeric polysiloxanes, and organopolysiloxane resins, as described for example, in U.S. Pat. No. 5,262,507. Other toughening agents may include carboxyl terminated butadiene, polysulfide-based toughening agents, amine-terminated butadiene nitrile, and polythioethers, as described for example, in U.S. Pat. Nos. 7,087,304 and 7,037,958.

Kinloch et al., “Toughening structural adhesives via nano- and micro-phase inclusions,” Journal of Adhesion (2003), 79(8-9), 867-873 describe the use of nanosilica and ATBN or CTBN toughening agents in epoxy thermoset compositions, and the resulting impact on glass transition temperature, toughness and other properties.

There has been some previous work on developing block co-polymers toughening agents that will give better toughness without sacrificing other key properties (both processing and end use). For example, WO 2006052729 teaches amphiphilic block copolymer-toughened epoxy resins including for example epoxy resins toughened with an all polyether block copolymer such as a poly(ethylene oxide)-b-poly(butylene oxide) (PEO-PBO) diblock or a PEO-PBO-PEO triblock copolymer.

To overcome the brittleness issue, toughening agents such as those described above are added to epoxy thermosets. However, many of the existing toughening agents cause unwanted side issues for the resultant thermoset such as a significant reduction in a key performance attribute of the thermoset; or an increase in the viscosity of a thermoset formulation, which makes it hard to process the thermoset formulation. In addition, the use of existing toughening agents is very expensive. No one technology has proven 100% successful in resolving all of these issues. Therefore, there remains a continuing need for toughening agents that give a better balance of properties. Also, so far no one toughening agent has been found that works in all thermoset formulations.

An epoxy formulation for use in composite molding processes, such for example a Vacuum Resin Infusion Molding process, traditionally utilize a combination of low viscosity, slow and fast amine functional curing agents to balance processing viscosity, pot life, cure speed, glass transition temperature and cost. For example, polyoxypropyleneamine (D230), and isophoronediamine (IPD) in combination with aminoethylpiperazine (AEP), provides an acceptable balance. However, the cured combination is only mediocre in terms of fracture toughness properties and glass transition temperature.

The use of the aforementioned toughening technologies will have a negative impact on that balance and likely to reduce the glass transition temperature. Furthermore, AEP is becoming short in supply and there is a need in the industry to find a functional replacement for AEP. It is therefore desired to provide a readily available, affordable, curing agent having similar function to prior art curing agents without compromising the overall physical properties of the original epoxy formulation containing the AEP curing agent. As such there still exists a need for cured epoxies having good ductility and good stiffness properties.

### SUMMARY OF THE INVENTION

The present invention is directed to curable epoxy resin compositions, cured epoxy resin compositions, and processes of forming the same, including an epoxy resin, a sterically hindered amine curing agent and a non-sterically hindered amine curing agent which provides toughness properties to the curable composition and to the resultant cured product made from the curable composition.

In one aspect, embodiments disclosed herein relate to a curable epoxy resin composition, comprising:

(a) at least one or more epoxy resins having an average of more than one glycidyl ether group per molecule;

(b) at least one or more sterically hindered amine functional curing agents having at least two sterically hindered amine groups per molecule; and

(c) at least one or more non-sterically hindered amine functional curing agents having at least two non-sterically hindered amine functional groups per molecule.

In another aspect, embodiments disclosed herein relate to a process of forming a curable epoxy resin composition, comprising admixing:

(a) at least one or more epoxy resins having an average of more than one glycidyl ether group per molecule;

(b) at least one or more sterically hindered amine functional curing agents having at least two hindered amine functional groups per molecule; and

(c) at least one or more non-sterically hindered amine functional curing agents having at least two non-sterically hindered amine functional groups per molecule.

In still another aspect, embodiments disclosed herein relate to a composite, comprising:

(a) at least one or more epoxy resins having an average of more than one glycidyl ether group per molecule;

(b) at least one or more sterically hindered amine functional curing agents having at least two sterically hindered amine functional groups per molecule; and

(c) at least one or more non-sterically hindered amine functional curing agents having at least two non-sterically hindered amine functional groups per molecule to form a composite.

In yet another aspect, embodiments disclosed herein relate to a process of forming a composite, including:

(I) admixing:

(a) at least one or more epoxy resins having an average of more than one glycidyl ether group per molecule;

(b) at least one or more sterically hindered amine functional curing agents having at least two sterically hindered amine functional groups per molecule; and

(c) at least one or more non-sterically hindered amine functional curing agents having at least two non-sterically hindered amine functional groups per molecule to form a curable composition; and

(II) curing the curable composition to form a composite.

Other aspects and advantages will be apparent from the following description and the appended claims.

### DETAILED DESCRIPTION OF THE PREFERRED EMBODIMENTS

Composites and curable compositions disclosed herein having improved fracture toughness may include (a) at least one or more epoxy resins having an average of more than one glycidyl ether group per molecule; (b) at least one or more sterically hindered amine functional curing agents having at least two sterically hindered amine functional groups per molecule; and (c) at least one or more non-sterically hindered amine functional curing agents having at least two non-sterically hindered amine functional groups per molecule.

The curable compositions may also include other amine hardeners or other co-curing agents, catalysts and other additives. Each of these components is described in detail below.

The epoxy resins, used in embodiments disclosed herein for component (a) of the present invention, may vary and include conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

The epoxy resins, component (a), useful in the present invention for the preparation of the curable compositions, are commercially available products containing more than one epoxy group per molecule and are derived from mono- and polyvalent, mono- and/or polynuclear phenols, in particular bisphenols, and from novolacs. An extensive enumeration of these di- and polyphenols is found in Lee, H. and Neville, K., “Handbook of Epoxy Resins,” McGraw-Hill Book Company, New York, 1967, Chapter 2, pages 257-307.

The epoxy resin component (a) may be any type of epoxy resin, including any material containing one or more reactive oxirane groups, referred to herein as “epoxy groups” or “epoxy functionality.” Epoxy resins useful in embodiments disclosed herein may include mono-functional epoxy resins, multi- or poly-functional epoxy resins, and combinations thereof. Monomeric and polymeric epoxy resins may be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene epoxy resin, for example) and polymers having pendant epoxy groups (such as a glycidyl methacrylate polymer or copolymer, for example). The epoxies may be pure compounds, but are generally mixtures or compounds containing one, two or more epoxy groups per molecule. In some embodiments, epoxy resins may also include reactive —OH groups, which may react at higher temperatures with anhydrides, organic acids, amino resins, phenolic resins, or with epoxy groups (when catalyzed) to result in additional crosslinking.

In general, the epoxy resins may be glycidated resins, cycloaliphatic resins, epoxidized oils, and so forth. The glycidated resins are frequently the reaction product of epichlorohydrin and a bisphenol compound, such as bisphenol A; C₄ to C₂₈ alkyl glycidyl ethers; C₂ to C₂₈ alkyl- and alkenyl-glycidyl esters; C₁ to C₂₈ alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphynyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms. Other examples of epoxy resins useful in embodiments disclosed herein include bis-4,4′-(1-methylethylidene) phenol diglycidyl ether and (chloromethyl) oxirane bisphenol A diglycidyl ether.

In some embodiments, the epoxy resin component (a) may include glycidyl ether type; glycidyl-ester type; alicyclic type; heterocyclic type, and halogenated epoxy resins, etc. Non-limiting examples of suitable epoxy resins may include cresol novolac epoxy resin, phenolic novolac epoxy resin, biphenyl epoxy resin, hydroquinone epoxy resin, stilbene epoxy resin, and mixtures and combinations thereof.

Suitable polyepoxy compounds, useful as component (a) of the presnt invention, may include resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidyl ether of bromobisphenol A (2,2-bis(4-(2,3-epoxypropoxy)-3-bromo-phenyl)propane), diglycidylether of Bisphenol F (2,2-bis(p-(2,3-epoxypropoxy)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds. A more exhaustive list of useful epoxy resins may be found in the above Lee, H. and Neville, K. reference.

Other suitable epoxy resins useful in the present invention include polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate. Epoxy resins may also include glycidyl derivatives of one or more of: aromatic diamines, aromatic monoprimary amines, aminophenols, polyhydric phenols, polyhydric alcohols, polycarboxylic acids.

Other epoxy resins useful in the present invention include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-naphthalene dicarboxylic acid, and dimerized linoleic acid; polyglycidyl ethers of polyphenols, such as, for example, bisphenol A, bisphenol F, 1,1-bis(4-hydroxyphenyl)ethane, 1,1-bis(4-hydroxyphenyl)isobutane, and 1,5-dihydroxy naphthalene; modified epoxy resins with acrylate or urethane moieties; glycidylamine epoxy resins; and novolac resins.

Further epoxy-containing materials which are particularly useful as component (a) of the present invention, include those based on glycidyl ether monomers. Examples are di- or polyglycidyl ethers of polyhydric phenols obtained by reacting polyhydric phenol with an excess of chlorohydrin such as epichlorohydrin. Such polyhydric phenols include resorcinol, bis(4-hydroxyphenyl)methane (known as bisphenol F), 2,2-bis(4-hydroxyphenyl)propane (known as bisphenol A), 2,2-bis(4′-hydroxy-3′, 5′-dibromophenyl)propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Still other epoxy-containing materials, useful as component (a) of the present invention, are copolymers of acrylic acid esters of glycidol such as glycidylacrylate and glycidylmethacrylate with one or more copolymerizable vinyl compounds. Examples of such copolymers are 1:1 styrene-glycidylmethacrylate, 1:1 methylmethacrylate-glycidylacrylate and a 62.5:24:13.5 methylmethacrylate-ethyl acrylate-glycidylmethacrylate.

Epoxy resin compounds, useful for component (a), that are readily available include octadecylene oxide; glycidylmethacrylate; diglycidyl ether of bisphenol A; D.E.R. 331, D.E.R. 332 and D.E.R. 334 from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl) adipate; bis(2,3-epoxycyclopentyl) ether; aliphatic epoxy modified with polypropylene glycol; dipentene dioxide; epoxidized polybutadiene; silicone resin containing epoxy functionality; flame retardant epoxy resins (such as a brominated bisphenol type epoxy resin available under the tradename D.E.R. 580, available from The Dow Chemical Company); 1,4-butanediol diglycidyl ether of phenol-formaldehyde novolac (such as those available under the tradenames D.E.N. 431 and D.E.N. 438 available from The Dow Chemical Company); and resorcinol diglycidyl ether. Other epoxy resins under the tradename designations D.E.R. and D.E.N. available from the Dow Chemical Company may also be used. In some embodiments, epoxy resin compositions may include epoxy resins formed by reacting a diglycidyl ether of bisphenol A with bisphenol A.

As an illustration of the present invention, the epoxy resin component (a) may be a liquid epoxy resin, D.E.R.® 383 [diglycidylether of bisphenol A (DGEBPA)] having an epoxide equivalent weight of about 175-185, a viscosity of about 9.5 Pa-s and a density of about 1.16 gms/cc. Other commercial epoxy resins that can be used for the epoxy resin component can be, for example, D.E.R. 330, D.E.R. 354, or D.E.R. 332.

In combination with the above first epoxy resin component (a), a second epoxy resin component (a) may be used such as 1,4 butanedioldiglycidylether, Polystar® 67 with a viscosity of about 1-6 mPa-s, an epoxide equivalent weight of about 165-170 and a density of about 1.00 gms/cc. This second epoxy resin component (a) may be substituted, for example, with 1,6 hexanedioldiglycidylether, neopentylglycoldiglycidyl ether, D.E.R. 736, or D.E.R. 732.

Other suitable epoxy resins useful as component (a) are disclosed in, for example, U.S. Pat. Nos. 7,163,973; 6,887,574; 6,632,893; 6,242,083; 7,037,958; 6,572,971; 6,153,719; and 5,405,688; PCT Publication WO 2006/052727; and U.S. Patent Application Publication Nos. 20060293172 and 20050171237; each of which is hereby incorporated herein by reference.

The desired amount of epoxy resin component (a) used in the curable composition may depend on the expected end use. Additionally, in one particular embodiment as detailed as follows, reinforcing materials may be used at substantial volume fractions; thus, the desired amount of epoxy resin may also depend on whether or not a reinforcing material is used. In some embodiments, in general, curable compositions may include from about 15 weight percent (wt %) to about 90 wt % epoxy resin. In other embodiments, curable compositions may include from about 25 wt % to about 90 wt % epoxy resin; from about 35 wt % to about 90 wt % epoxy resin in other embodiments; from about 45 wt % to about 90 wt % epoxy resin in other embodiments; and from about 55 wt % to about 90 wt % epoxy resin in yet other embodiments.

“Steric hindrance” or “sterically hindered” when used in reference to the amine curing agents of the present invention (component b), pertains to the spatial arrangement of groups in proximity to the reactive functionality, such that it reduces the physical accessibility of that reactivity functionality. This restricted physical accessibility renders the reactive group “less” reactive. Generic examples of such hindered amine functionality are depicted in the following structures (I), (II), and (III):

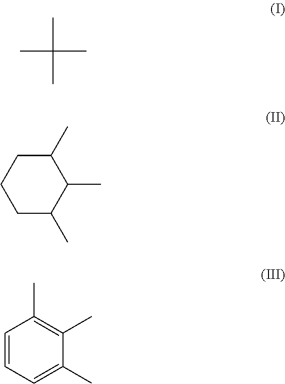

The sterically hindered amine functional curing agents, component (b), used in the present invention include for example 3-poly(oxypropylene diamine) Jeffamine® D230, with a viscosity of about 10-15 mPa-s, an amine hydrogen equivalent weight of about 60, and a density of about 7.9 lb/gal. The sterically hindered amine curing agents used in the present invention may also include Jeffamine® D-400, D-2000, or T-403

Other sterically hindered amine curing agents used in the present invention may include for example diethyltoluenediamine (e.g. Ethacure® 100), dimethylthiotoluenediamine (e.g. Ethacure 300), (3,3′-dimethyl-4,4′diaminocyclohexylmethane (e.g. Laromin® C260), 3-cyclohexylaminopropylamine (e.g. Laromin C252), 4,4′-diaminodiphenylmethane, (MDA), metaphenylenediamine (MPDA), methylenedianiline (MDA), 3,3′-diaminodiphenylsulphone (DDS), para-aminocycohexylamine (e.g. PACM 20), 1,3-bis(aminomethyl)cyclohexane (1,3-BAC) and meta-xylenediamine (MXDA); and mixtures thereof.

The curable epoxy resin compositions of the present invention may include from about 5 wt % to about 25 wt % of a sterically hindered amine functional curing agent in some embodiments. In other embodiments, curable compositions may include from about 5 wt % to about 20 wt % of a sterically hindered amine functional curing agent; and from about 5 wt % to about 16 wt % of a sterically hindered amine functional curing agent in yet other embodiments.

“Non-sterically hindered” or “non-sterically hindered amine functional cureing agent” when used in reference to the amine curing agents of the present invention (component c), refers to when one of three hydrogen atoms in ammonia is replaced by an organic substituent in such a way, the spatial arrangement of groups in proximity to the reactive amine functionality does not reduce the physical accessibility of that reactive amine functionality. This unrestricted physical accessibility renders the reactive amine group “more” reactive. A generic example of such primary amine functionality is depicted in the following structure. (IV)

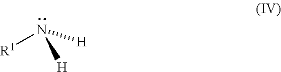

The non-sterically hindered amine functional curing agents, component (c), used in the present invention include for example diethylenetriamine, DEH 20, with a viscosity of about 4-8 mPa-s, an amine hydrogen equivalent weight of about 20.6 and a density of about 7.9 lb/gal. The amine functional curing agent used in the present invention may include other amine compounds such as ethylene diamine (EDA) available from The Dow Chemical Company, triethylene tetramine (e.g. D.E.H. 24, available from The Dow Chemical Company), and tetraethylene pentamine (e.g. D.E.H. 26, available from The Dow Chemical Company) as well as adducts of the above amines with epoxy resins, diluents, or other amine-reactive compounds. The curable epoxy resin compositions of the present invention may include from about 5 wt % to about 25 wt % of a non-sterically hindered amine functional curing agent in some embodiments. In other embodiments, curable compositions may include from about 5 wt % to about 20 wt % of a non-sterically hindered amine functional curing agent; and from about 5 wt % to about 15 wt % of a non-sterically hindered amine functional curing agent in yet other embodiments.

Other amines found suitable for the present invention include 1,3-diaminopropane, dipropylenetriamine, 3-(2-aminoethyl) amino-propylamine (N₃-amine), N,N′-bis(3-aminopropyl)-ethylenediamine (N₄-amine), 4,9-dioxadodecane-1,12-diamine, 4,7,10-trioxamidecane-1,13-diamine, hexamethylenediamine (HMD), 2-methylpentamethylenediamine (e.g. DYTEK® A), 1,3 pentanediamine (e.g. DYTEK EP) as well as adducts of the above amines with epoxy resins, diluents, or other amine-reactive compounds. The curable epoxy resin compositions of the present invention may include from about 5 wt % to about 25 wt % of a primary functional amine curing agent in some embodiments. In other embodiments, curable compositions may include from about 5 wt % to about 20 wt % of a primary amine functional curing agent; and from about 5 wt % to about 15 wt % of a primary amine functional curing agent in yet other embodiments.

The combination of sterically hindered and non-sterically hindered amine curing agents are used in the present invention to prevent the composites disclosed herein from becoming brittle when the epoxy resins used in the composite are cured. The combination of sterically hindered and non-sterically hindered amine curing agents function by forming an interpenetrating network (IPN) throughout the polymer matrix. The interpenetrating network is capable of crack growth arrestment, providing improved fracture toughness. The combination of a sterically hindered amine functional curing agents and non-sterically hindered amine functional curing agents of the present invention has been found to be useful in toughening various epoxy resin thermoset systems.

The combination of sterically hindered amine functional curing agents and non-stirically hindered amine functional curing agents, can improve the fracture toughness and adhesive bond strength of epoxy amine resin systems without negatively effecting moisture/chemical resistance and thermo-mechanical properties. Without being limited to any particular theory herein, it is believed that the non-sterically hindered amine termination of component (c) reacts more quickly to form an IPN. The sterically hindered amine functionality of the sterically hindered amine curing agent, such as D230, reacts more slowly to form a matrix surrounding the IPN. It is believed that there is a synergistic effect between the two networks that provides increased fracture toughness properties to the resultant cured epoxy resin composition.

For example, the use of poly(oxypropylenediamine) (e.g. Jeffamine D230) and diethylenetriamine (e.g. D.E.H. 20), reacts with the overall epoxy resin system and improves the fracture toughness values of the cured polymer without negatively effecting other thermo-mechanical properties of the epoxy resin composition. Such improvements in fracture toughness are potentially related to the enhanced fatigue life of composite structures. The present invention can be used to improve the fracture toughness performance of vacuum resin infusion systems over that of the prior art systems. The present invention can be used to increase secondary bond strength of hand lay-up formulations for composites and adhesive formulations in general.

The curable epoxy resin compositions of the present invention may include from about 1 wt % to about 65 wt % sterically hindered and non-sterically hindered amine functional curing agents in some embodiments. In other embodiments, curable compositions may include from about 1 wt % to about 40 wt % sterically hindered and non-sterically hindered amine functional curing agents; and from about 1 wt % to about 15 wt % sterically hindered and non-sterically hindered amine functional curing agents in yet other embodiments.

As an illustration of the present invention, the amount of D.E.H. 20 used in the epoxy resin composition is from about 1 wt % to about 20 wt % based on total composition in combination with a Jeffamine D230; and preferably about 1 wt % to about 12 wt % D.E.H. 20 based on total composition in combination with Jeffamine D230.

The present invention may include one or more other additional different toughening agents along with the sterically hindered and non-sterically hindered amine functional curing agents which provide the primary toughening of the epoxy resin composition. For example, in some embodiments, the other toughening agents may be rubber compounds and/or block copolymers.

Rubber toughening agents (second-phase) such as carboxyl terminated butadiene or amine terminated butadiene may be used. Such toughening agents are described in “EPDXY RESINS—Chemistry and Technology,” by Clayton May, 2^{nd} Ed., Chapter 5, pp 551-560, Marcel Dekker, Inc., 1988; incorporated herein by reference.

Various amphiphilic block copolymers may also be used as the other toughening agents in embodiments disclosed herein. Amphiphilic polymers are described in, for example, U.S. Pat. No. 6,887,574 and WO 2006/052727; each of which is incorporated herein by reference. For example, amphiphilic polyether block copolymers used in embodiments disclosed herein may include any block copolymer containing an epoxy resin miscible block segment; and an epoxy resin immiscible block segment.

In some embodiments, suitable block copolymers include amphiphilic polyether diblock copolymers such as, for example, poly(ethylene oxide)-b-poly(butylene oxide) (PEO-PBO) or amphiphilic polyether triblock copolymers such as, for example, poly(ethylene oxide)-b-poly(butylene oxide)-b-poly(ethylene oxide) (PEO-PBO-PEO).

Other suitable amphiphilic block copolymers include, for example, poly(ethylene oxide)-b-poly(ethylene-alt propylene) (PEO-PEP), poly(isoprene-ethylene oxide) block copolymers (PI-b-PEO), poly(ethylene propylene-b-ethylene oxide) block copolymers (PEP-b-PEO), poly(butadiene-b-ethylene oxide) block copolymers (PB-b-PEO), poly(isoprene-b-ethylene oxide-b-isoprene) block copolymers (PI-b-PEO-PI), poly(isoprene-b-ethylene oxide-b-methylmethacrylate) block copolymers (PI-b-PEO-b-PMMA); and mixtures thereof.

Other useful amphiphilic block copolymers are disclosed in PCT Patent Application Publications WO2006/052725, WO2006/052726, WO2006/052727, WO2006/052729, WO2006/052730, and WO2005/097893, U.S. Pat. No. 6,887,574, and U.S. Patent Application Publication No. 20040247881; each of which is incorporated herein by reference.

The amount of optional additional toughening agent used in the curable compositions described herein may depend on a variety of factors including the equivalent weight of the polymers, as well as the desired properties of the products made from the composition. In general, the amount of optional toughening agent may be from about 1.0 wt % to about 55 wt % in some embodiments, from about 1.0 wt % to about 30 wt % in other embodiments, and from about 1 wt % to about 10 wt % in yet other embodiments, based on the total weight of the curable composition.

Optionally, one or more other additional different amine curing agents, other than the sterically hindered and non-sterically hindered amine functional curing agents or the amine functional toughening agents, may be used in the present invention. For example, isophorone diamine (IPD) [e.g. Vestamin IPD] with a viscosity of about 10-20 mPa-s, an amine hydrogen equivalent weight of about 44 and a density of about 0.9225 gms/cc may be added to the composition of the present invention. Other amine curing agents useful in the epoxy resin composition may include for example 1,2 diaminocyclohexane (DACH); p-amino dicyclohexylmethane (e.g. PACM 20); 1,3 bis aminomethyl cyclohexane (1,3 BAC); 3′-dimethyl-4,4′diamino dicyclohexylmethane (e.g. Laromin C260); 3-cyclohexylaminopropylamine (e.g. Laromin C252); or mixtures thereof.

The specific amount of optional other amine curing agent used for a given system should be determined experimentally to develop the optimum in properties desired. Variables to consider in selecting a curing agent and an amount of curing agent may include, for example, the epoxy resin composition (if a blend), the desired properties of the cured composition (flexibility, electrical properties, etc.), desired cure rates, as well as the number of reactive groups per catalyst molecule, such as the number of active hydrogens in an amine.

The amount of other optional amine curing agents used in the present invention may vary from about 1 to about 50 parts per hundred parts epoxy resin, by weight, in some embodiments. In other embodiments, the optional amine curing agent may be used in an amount ranging from about 1 to about 36 parts per hundred parts epoxy resin, by weight; and the curing agent may be used in an amount ranging from about 1 to about 23 parts per hundred parts epoxy resin, by weight, in yet other embodiments.

One or more other optional hardeners or curing agents that are different from the sterically hindered amine functional curing agents and the non-sterically hindered amine functional curing agents, may be used in the epoxy resin composition of the present invention to promote further cros slinking of the epoxy resin composition to form a polymer composition. As with the epoxy resins, the hardeners and curing agents may be used individually or as a mixture of two or more.

The other optional curing agent component (also referred to as a hardener or cross-linking agent), as a co-curing agent, may include any compound having an active group being reactive with the epoxy group of the epoxy resin. The co-curing agents may include nitrogen-containing compounds such as amines and their derivatives; oxygen-containing compounds such as carboxylic acid terminated polyesters, anhydrides, phenol-formaldehyde resins, brominated phenolic resins, amino-formaldehyde resins, phenol, bisphenol A and cresol novolacs, phenolic-terminated epoxy resins; sulfur-containing compounds such as polysulfides, polymercaptans; and catalytic co-curing agents such tertiary amines, Lewis acids, Lewis bases and combinations of two or more of the above co-curing agents. Practically, polyamines, dicyandiamide, diaminodiphenylsulfone and their isomers, aminobenzoates, various acid anhydrides, phenol-novolac resins and cresol-novolac resins, for example, may be used, but the present disclosure is not restricted to the use of these compounds.

In some embodiments, co-curing agents may include primary and secondary polyamines and their adducts, anhydrides, and polyamides. For example, polyfunctional amines may include aliphatic amine compounds such as diethylene triamine (e.g. D.E.H. 20, available from The Dow Chemical Company), triethylene tetramine (e.g. D.E.H. 24, available from The Dow Chemical Company), tetraethylene pentamine (e.g. D.E.H. 26, available from The Dow Chemical Company), as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine, may also be used as the co-curing agent.

Other examples of co-curing agents useful in embodiments disclosed herein include: 3,3′- and 4,4′-diaminodiphenylsulfone; methylenedianiline; bis(4-amino-3,5-dimethylphenyl)-1,4-diisopropylbenzene available for example, as EPON 1062 from Shell Chemical Co.; and bis(4-aminophenyl)-1,4-diisopropylbenzene available for example, as EPON 1061 from Shell Chemical Co.; and mixtures thereof.

Aliphatic polyamines that are modified by adduction with epoxy resins, acrylonitrile, or (meth)acrylates may also be utilized as co-curing agents. In addition, various Mannich bases can be used. Aromatic amines wherein the amine groups are directly attached to the aromatic ring may also be used.

The amount of other optional co-curing agents used in the present invention may vary from about 1 part per hundred parts epoxy resin to about 50 parts per hundred parts epoxy resin, by weight, in some embodiments. In other embodiments, the optional co-curing agents may be used in an amount ranging from about 1 part per hundred parts epoxy resin to about 28 parts per hundred parts epoxy resin, by weight; and the co-curing agent may be used in an amount ranging from about 1 part per hundred parts epoxy resin to about 15 parts per hundred parts epoxy resin, by weight, in yet other embodiments.

The epoxy resin composition of the present invention may also include a catalyst as an optional component. The catalyst may be a single component or a combination of two or more different catalysts. Catalysts useful in the present invention are those catalysts which catalyze the reaction of an epoxy resin with a cross-linker, and which remain latent in the presence of an inhibitor at lower temperatures. Preferably, the catalyst is latent at temperatures of 140° C. or below, and more preferably at 150° C. or below. Latency is demonstrated by an increase of at least 10 percent in gel time as determined by a stroke cure test performed at 150° C. to 170° C.

Examples of suitable catalyst useful for the composition of the present invention may include compounds containing amine, phosphine, heterocyclic nitrogen, ammonium, phosphonium, arsonium, sulfonium moieties, and any combination thereof. More preferred catalysts are the heterocyclic nitrogen-containing compounds and amine-containing compounds and even more preferred catalysts are the heterocyclic nitrogen-containing compounds.

The amine and phosphine moieties in catalysts are preferably tertiary amine and phosphine moieties; and the ammonium and phosphonium moieties are preferably quaternary ammonium and phosphonium moieties. Among preferred tertiary amines that may be used as catalysts are those mono- or polyamines having an open-chain or cyclic structure which have all of the amine hydrogen replaced by suitable substituents, such as hydrocarbyl radicals, and preferably aliphatic, cycloaliphatic or aromatic radicals. Examples of suitable heterocyclic nitrogen-containing catalysts useful in the present invention include those described in U.S. Pat. No. 4,925,901; incorporated herein by reference.

Heterocyclic secondary and tertiary amines or nitrogen-containing catalysts which can be employed herein include, for example, imidazoles, benzimidazoles, imidazolidines, imidazolines, oxazoles, pyrroles, thiazoles, pyridines, pyrazines, morpholines, pyridazines, pyrimidines, pyrrolidines, pyrazoles, quinoxalines, quinazolines, phthalozines, quinolines, purines, indazoles, indoles, indolazines, phenazines, phenarsazines, phenothiazines, pyrrolines, indolines, piperidines, piperazines, and any combination thereof or the like. Especially preferred are the alkyl-substituted imidazoles; 2,5-chloro-4-ethyl imidazole; and phenyl-substituted imidazoles, and any mixture thereof. Examples of preferred embodiments of the catalysts useful in the present invention include N-methylimidazole; 2-methylimidazole; 2-ethyl-4-methylimidazole; 1,2-dimethylimidazole; 2-methylimidazole and imidazole-epoxy reaction adducts. More preferred embodiments of the catalysts include for example 2-phenylimidazole, 2-methylimidazole and 2-methylimidazole-epoxy adducts.

Most preferred examples of the catalyst suitable for the present invention include imidazole such as 2-methylimidazole, 2-phenylimidazole, or other imidazole derivatives; 1,8-Diazabicyclo[5.4.0]undec-7-ene (DBU), 2-methyl imidazole-epoxy adduct, such as EPON™ P101 (available from Hexion Chemical), a boric acid complex of 2-methylimidazole, isocyanate-amine adduct (available from Degussa); and any combination thereof.

Any of the well known catalysts described in U.S. Pat. No. 4,925,901, may be used in the present invention. As an illustration, examples of the known catalysts that may be used in the present invention, include for example, suitable onium or amine compounds such as ethyltriphenyl phosphonium acetate, ethyltriphenyl phosphonium acetate-acetic acid complex, triethylamine, methyl diethanolamine, benzyldimethylamine, and imidazole compounds such as 2-methylimidazole and benzimidazole.

The catalysts, when present in the epoxy resin composition, are employed in a sufficient amount to result in a substantially complete cure of the epoxy resin, with some cross-linking. For example, the catalyst may be used in an amount of from 0.01 to 5 parts per hundred parts of resin, with from 0.01 to 1.0 part per hundred parts of resin being preferred and from 0.02 to 0.5 per hundred parts of resin being more preferred.

In general, the amount of catalyst, present in the curable resin composition, may be from about 0.1 wt % to about 10 wt %; preferably, from about 0.2 wt % to about 10 wt %; more preferably, from about 0.4 wt % to about 6 wt %; and most preferably, from about 0.8 wt % to about 4 wt % based on the total weight of the curable resin composition.

Concentrations of components used to describe in the present invention are measured as parts by weight of components per hundred parts of resin by weight (phr), unless otherwise noted. The “resin” in the definition of “phr” herein refers to the epoxy resin and the hardener together in the composition.

Another optional component useful in the epoxy resin composition of the present invention is a reaction inhibitor. The reaction inhibitor may include boric acid, Lewis acids containing boron such as alkyl borate, alkyl borane, trimethoxyboroxine, an acid having a weak nucleophilic anion, such as, perchloric acid, tetrafluoboric acid, and organic acids having a pKa from 1 to 3, such as, salicylic acid, oxalic acid and maleic acid. Boric acid as used herein refers to boric acid or derivatives thereof, including metaboric acid and boric anhydride; and combinations of a Lewis acid with boron salts such as alkyl borate or trimethoxyboroxine. When an inhibitor is used in the present invention, boric acid is preferably used. The inhibitor and catalyst may be separately added, in any order, to the epoxy resin composition of the present invention, or may be added as a complex.

The amount of the inhibitor present relative to the catalyst in the epoxy resin composition of the present invention can be adjusted to adjust the gel time of the epoxy resin composition. At constant levels of catalyst, an increasing amount of inhibitor will yield a corresponding increase in the gel time. At a desired catalyst level the relative amount of inhibitor can be decreased to decrease the gel time. To increase the gel time the amount of inhibitor can be increased without changing the catalyst level.

The molar ratio of inhibitor (or mixture of different inhibitors) to catalyst is that ratio which is sufficient to significantly inhibit the reaction of the epoxy resin as exhibited by an increase in gel time as compared to a like composition free of inhibitor. Simple experimentation can determine the particular levels of inhibitor or mixtures which will increase in gel time but still allow a complete cure at elevated temperatures. For example, a preferable molar ratio range of inhibitor to catalyst where up to about 5.0 phr of boric acid is used, is from about 0.1:1.0 to about 10.0:1.0, with a more preferred range being from about 0.4:1.0 to about 7.0:1.0.

Another optional component which may be added to the epoxy resin composition of the present invention is a solvent or a blend of solvents. One or more solvents may be present in the curable epoxy resin composition of the present invention. The presence of a solvent or solvents can improve the solubility of the reactants or, if the reactant is in a solid form, dissolve the solid reactant for easy mixing with other reactants.

The solvent may be any solvent which is substantially inert to the other components in the epoxy resin composition including inert to the reactants, the intermediate products if any, and the final products. Examples of the suitable solvents useful in the present invention include aliphatic, cycloaliphatic and aromatic hydrocarbons, halogenated aliphatic and cycloaliphatic hydrocarbons, aliphatic and cycloaliphatic secondary alcohols, aliphatic ethers, aliphatic nitriles, cyclic ethers, glycol ethers, esters, ketones, ethers, acetates, amides, sulfoxides, and any combination thereof.

Preferred examples of the solvents include pentane, hexane, octane, cyclohexane, methylcyclohexane, toluene, xylene, methylethylketone, methylisobutylketone, cyclohexanone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, N,N-dimethylacetamide, acetonitrile, isopropanol, and any combination thereof.

Preferred solvents for the catalyst and the inhibitor are polar solvents. Lower alcohols having from 1 to 20 carbon atoms, such as for example methanol, provide good solubility and volatility for removal from the resin matrix.

Polar solvents are particularly useful to dissolve inhibitors of boric acid or Lewis acids derived from boron. If the polar solvents are hydroxy containing, there exists a potential competition for available carboxylic acid anhydride between the hydroxy moiety of the solvent and the secondary hydroxyl formed on opening of the oxirane ring. Thus, polar solvents which do not contain hydroxyl moieties are useful, for example, N,-methyl-2-pyrrolidone, dimethylsulfoxide, dimethylformamide, and tetrahydrofuran. Also useful are dihydroxy and trihydroxy hydrocarbons optionally containing ether moieties or glycol ethers having two or three hydroxyl groups. Particular useful are C₂₋₄ di- or trihydroxy compounds, for example 1,2-propane diol, ethylene glycol and glycerine. The polyhydroxy functionality of the solvent facilitates the solvent serving as a chain extender, or as a co-cross-linker according to the possible mechanism previously described concerning co-cross-linkers.

The total amount of solvent used in the epoxy resin composition generally may be between about 20 wt % and about 60 wt %, preferably between about 30 wt % and about 50 wt %, and most preferably between about 35 wt % and about 45 wt %.

The curable composition of the present invention may also include one or more optional additives and fillers conventionally found in epoxy resin systems. Additives and fillers may include for example calcium carbonate, silica, glass, talc, metal powders, titanium dioxide, wetting agents, pigments, coloring agents, dyes, mold release agents, toughening agents, coupling agents, flame retardants, ion scavengers, UV stabilizers, flexibilizing agents, thixotropic agents, fluidity control agents, surfactants, stabilizers, diluents, adhesion promoters, and tackifying agents. Additives and fillers may also include fumed silica, aggregates such as glass beads, polytetrafluoroethylene, polyol resins, polyester resins, phenolic resins, graphite, molybdenum disulfide, abrasive pigments, viscosity reducing agents, boron nitride, mica, nucleating agents, and stabilizers, among others. Fillers and modifiers may be preheated to drive off moisture prior to addition to the epoxy resin composition. Additionally, these optional additives may have an effect on the properties of the composition, before and/or after curing, and should be taken into account when formulating the composition and the desired reaction product.

The amount of other optional additives used in the present invention may vary from about 0.01 to about 80 parts per hundred parts epoxy resin, by weight, in some embodiments. In other embodiments, the optional additives may be used in an amount ranging from about 0.05 to about 70 parts per hundred parts epoxy resin, by weight; and the additives may be used in an amount ranging from about 0.1 to about 60 parts per hundred parts epoxy resin, by weight, in yet other embodiments.

Curable or hardenable compositions disclosed herein may be prepared by admixing the components aforementioned above including, for example, at least one epoxy resin, at least one sterically hindered amine curing agent and at least one amine functional toughening agent. In other embodiments, curable compositions disclosed herein may include a reinforcing material.

The curable compositions of the present invention may be prepared by admixing all of the components of the composition together in any order. Alternatively, the curable epoxy resin composition of the present invention can be produced by preparing a first composition comprising the epoxy resin component and a second composition comprising the curing agent component. All other components useful in making the epoxy resin composition may be present in the same composition, or some may be present in the first composition, and some in the second composition. The first composition is then mixed with the second composition to form the curable epoxy resin composition. The epoxy resin composition mixture is then cured to produce an epoxy resin thermoset material. Preferably, the curable epoxy resin composition is in the form of a solution wherein the components of the composition are dissolved in a solvent. Such solution or varnish is used for producing a composite article or coated article.

The curable epoxy resin compositions of the present invention may be used in any application that such curable epoxy resin compositions are used. In the present invention, the compositions containing the toughening agents of the present invention can be used wherever toughness in an epoxy system is needed, for example in the manufacture of composites, adhesives and sealants.

For example, the epoxy resin compositions described herein may be useful as adhesives, sealants, structural and electrical laminates, coatings, castings, structures for the aerospace industry, as circuit boards and the like for the electronics industry, as well as for the formation of skis, ski poles, fishing rods, and other outdoor sports equipment. The epoxy compositions disclosed herein may also be used in electrical varnishes, encapsulants, semiconductors, general molding powders, filament wound pipe, storage tanks, liners for pumps, and corrosion resistant coatings, among others.

The epoxy resins and the composites described herein may be produced by modifying conventional methods including introducing the toughening agents of the present invention to the epoxy resin composition before the composition is cured. In some embodiments, composites may be formed by curing the curable epoxy resin compositions disclosed herein. In other embodiments, composites may be formed by applying a curable epoxy resin composition to a reinforcing material, such as by impregnating or coating the reinforcing material, and then curing the curable epoxy resin composition with the reinforcing material.

The reinforcing material useful in the present invention may be any reinforcing material typically used for composites in the art. For example, the reinforcing material may be a fiber, including carbon/graphite; boron; quartz; aluminum oxide; glass such as E glass, S glass, S-2 GLASS® or C glass; and silicon carbide or silicon carbide fibers containing titanium. Commercially available fibers may include: organic fibers, such as KEVLAR; aluminum oxide-containing fibers, such as NEXTEL fibers from 3M; silicon carbide fibers, such as NICALON from Nippon Carbon; and silicon carbide fibers containing titanium, such as TYRRANO from Ube. When the reinforcing material is a fiber, it may be present at from about 20 percent by volume to about 70 percent by volume in some embodiments, and from about 50 percent by volume to about 65 percent by volume of the composite in other embodiments.

The fibers may be sized or unsized. When the fibers are sized, the sizing on the fibers is typically a layer of from about 100 nm to about 200 nm thick. When glass fibers are used, the sizing may be, for example a coupling agent, lubricant, or anti-static agent.

The fiber reinforcement may have various forms, and may be continuous or discontinuous, or combinations thereof. Continuous strand roving may be used to fabricate unidirectional or angle-ply composites. Continuous strand roving may also be woven into fabric or cloth using different weaves such as plain, satin, leno, crowfoot, and 3-dimensional. Other forms of continuous fiber reinforcement are exemplified by braids, stitched fabrics, and unidirectional tapes and fabrics.

Discontinuous fibers suitable for this invention may include milled fibers, whiskers, chopped fibers, and chopped fiber mats. When the reinforcing material is discontinuous, it may be added in an amount of from about 20 percent by volume to about 60 percent by volume of the composite in some embodiments, and from about 20 percent by volume to about 30 percent by volume of the composite in yet other embodiments. Examples of suitable discontinuous reinforcing materials include milled or chopped fibers, such as glass and calcium silicate fibers. An example of a discontinuous reinforcing material is a milled fiber of calcium silicate (e.g. wollastonite; such as NYAD G SPECIAL®).

A combination of continuous and discontinuous fibers may be used in the same composite. For example, a woven roving mat is a combination of a woven roving and a chopped strand mat, and it is suitable for use in embodiments disclosed herein.

A hybrid comprising different types of fibers may also be used. For example, layers of different types of reinforcement may be used. In aircraft interiors, for example, the reinforcing material may include a fiber and a core, such as a NOMEX honeycomb core, or a foam core made of polyurethane or polyvinylchloride. Another hybrid example, is the combination of glass fibers, carbon fibers, and aramid fibers.

The amount of reinforcing material in the composition may vary depending on the type and form of the reinforcing material and the expected end product. The curable epoxy resin compositions of the present invention may include from about 5 wt % to about 80 wt % reinforcing material in some embodiments. In other embodiments, curable compositions may include from about 35 wt % to about 80 wt % reinforcing material; and from about 55 wt % to about 80 wt % reinforcing material in yet other embodiments.

The epoxy resin compositions of the present invention may be cured ambiently or by heating. Curing of the epoxy resin compositions disclosed herein usually requires a temperature of at least about 20° C., up to about 200° C., for periods of minutes up to hours, depending on the epoxy resin, curing agent, and catalyst, if used. In other embodiments, curing may occur at a temperature of at least about 70° C., for periods of minutes up to hours. Post-treatments may be used as well, such post-treatments ordinarily being at temperatures between about 70° C. and about 200° C.

In some embodiments, curing may be staged to prevent exotherms. Staging, for example, includes curing for a period of time at a temperature followed by curing for a period of time at a higher temperature. Staged curing may include two or more curing stages, and may commence at temperatures below about 40° C. in some embodiments, and below about 80° C. in other embodiments.

Composites disclosed herein containing the toughening agents of the present invention may have higher fracture toughness than composites containing similar amounts of other toughening agents alone. As used herein, “similar amounts” refers to, for example, a composite including about 5 percent by volume of a toughening agent as compared to a composite according to embodiments disclosed herein including about 5 percent by volume of a toughening agent, such as about 2.5 percent by volume. In some embodiments, composites disclosed herein containing toughening agents may have a fracture toughness of at least about 20 percent greater than composites containing similar amounts of either toughening agents or sterically hindered amine curing agents alone.

In other embodiments, composites disclosed herein containing both toughening agents and sterically hindered amine curing agents may have a fracture toughness of at least about 30 percent greater than composites containing similar amounts of either toughening agents or sterically hindered amine curing agents alone; at least about 50 percent greater in other embodiments; and at least about 80 percent greater in yet other embodiments.

The epoxy resin compositions disclosed herein may be useful in composites containing high strength filaments or fibers such as carbon (graphite), glass, boron, and the like. Composites may contain from about 30% to about 70%, in some embodiments, and from about 40% to about 70% in other embodiments, of these fibers based on the total volume of the composite.

Fiber reinforced composites, for example, may be formed by hot melt prepregging. The prepregging method is characterized by impregnating bands or fabrics of continuous fiber with a thermosetting epoxy resin composition as described herein in molten form to yield a prepreg, which is laid up and cured to provide a composite of fiber and thermoset resin.

Other processing techniques can be used to form composites containing the epoxy-based compositions disclosed herein. For example, filament winding, solvent prepregging, and pultrusion are typical processing techniques in which the uncured epoxy resin may be used. Moreover, fibers in the form of bundles may be coated with the uncured epoxy resin composition, laid up as by filament winding, and cured to form a composite.

### EXAMPLES

The following examples illustrate, but do not limit the present invention. All parts and percentages are based upon weight, unless otherwise specified.

### Examples 1 and 2 and Comparative Examples A and B

Three 14 inches by 12 inches (356 millimeters [mm] by 305 mm) aluminum molds lined with DuoFoil are used to prepare 3.2 mm thick neat resin plaques. Approximately 325 grams (g) of the resin systems (Examples 1 and 2, and Comparative Examples A and B) described in Table I below, are blended at room temperature (about 25° C.) and degassed in a vacuum chamber until all foaming subsides. The resin systems are then poured into the molds at room temperature. The molds are immediately placed in a forced air convection oven programmed to heat up to 70° C., held for 7 hours, then cooled down to ambient temperature (about 25° C.) with the forced air convection circulating fan running continuously.

The resulting plaques are removed from the molds and visually inspected for inclusions, bubbles and defects. The plaques are then machined into 25 mm by 25 mm by 3 mm for the fracture toughness testing.

The results of the various test methods performed on the test specimens are described in Table I below. The resin system of Comparative Example A described in Table I is a reference control having values typical for such a system. By removing all the AEP and a portion of the D230 and replacing them with an equal portion of IPD, an increase in Tg (10%) and a reduction in Fracture Toughness (37.2%) was realized (Comparative Example B).

When the IPD was replaced with D.E.H. 20 and the ADDUCT to increase the reactivity of a resin system, it was unexpectedly and surprisingly fount that this resulted in a 1.8× increase in Fracture Toughness (Kᵢₚ) over Comparitive Example A, and a 2.9× increase in Fracture Toughness (KO over that of Comparitive Example B. The resulting increase in Fracture Toughness occurred without any degredation to the glass transition temperature of the system.

When the IPD was replaced with just D.E.H. 20 it was unexpectedly and surprisingly fount that this also resulted in a 1.8× increase in Fracture Toughness (KO over Comparitive Example A, and a 2.9× increase in Fracture Toughness (KO over that of Comparitive Example B. The resulting increase in Fracture Toughness occurred without any degredation to the glass transition temperature of the system.

TABLE I

| | | Comparative | Comparative | Example | Example |
|---|---|---|---|---|---|
| Resin Components | Acronym | Example A | Example B | 1 | 2 |
| Bisphenol A, diglycidylether | BADGE | 65.6 | 66.1 | 66.1 | 65.7 |
| 1,4 butanediol DGE | BDDGE | 10.7 | 10.8 | 10.8 | 15.7 |
| Curing Agent Component | | | | | |
| Poly(oxypropylene) diamine | D230 | 17.3 | 12.7 | 12.7 | 13.0 |
| Aminoethylpiperazine | AEP | 3.2 | | | |
| Isophorone diamine | IPD | 3.2 | 10.4 | | |
| diethylenetriamine | DEH20 | | | 6.9 | 5.6 |
| Adduct of diethylenetriame and | ADDUCT | | | 3.5 | |
| BADGE | | | | | |
| TOTAL | | 100 | 100 | 100 | 100 |
| Cured Resin Properties, (cured | | | | | |
| 7 hrs @ 70° C.) | | | | | |
| Fracture Toughness, | | 1.1 | 0.69 | 2.03 | 2.02 |
| ASTM-D5045 | | | | | |
| K_{1C,} (MPa-\sqrt{m}) | | | | | |
| Thermal Properties | | | | | |
| Glass Transition | | 80 | 87 | 87 | 85 |
| Temperature, DSC T_{g}1 (° C.) | | | | | |
| Glass Transition | | 87 | 92 | 90 | 92 |
| Temperature, DSC T_{g}2 ° C.) | | | | | |

While the present disclosure includes a limited number of embodiments, those skilled in the art, having benefit of this disclosure, will appreciate that other embodiments may be devised which do not depart from the scope of the present invention. Accordingly, the scope of the present invention should be limited only by the attached claims.

What is claimed is:

1. A curable epoxy resin composition, comprising:
(a) at least one or more epoxy resins having an average of more than one glycidyl ether group per molecule;
(b) one or more sterically hindered amine functional curing agents having at least two sterically hindered amine functional goups per molecule; and
(c) one or more non-sterically hindered amine functional curing agents having at least two non-sterically hindered amine groups per molecule.

2. The curable composition of claim 1, wherein the combination of sterically hindered amine functional curing agents and non-sterically hindered amine functional curing agents are present in a sufficient amount to increase the fracture toughness of the resultant cured product made from the curable epoxy resin composition while maintaining other thermo-mechanical properties of the resultant cured product.

3. The curable composition of claim 1, including (d) a co-curing agent different from the sterically hindered amine curing agent; and wherein the co-curing agent (d) different from the sterically hindered amine curing agent, is a non-sterically hindered amine having more than one reactive hydrogen per molecule.

4. The curable composition of claim 1, including (e) a second epoxy resin different from the epoxy resin component (a); and wherein the second epoxy resin (e) comprises 1,4 butanediol diglycidylether.

5. The curable composition of claim 3, wherein the epoxy resin (a) ranges from about 15 percent by weight to about 90 percent by weight of the curable composition; wherein the sterically hindered amine curing agent (b) ranges from about 5 percent by weight to about 25 percent by weight of the curable composition; wherein the non-sterically hinder amine functional curing agent (c) ranges from about 1 percent by weight to about 65 percent by weight of the curable composition; and wherein the co-curing agent (d) different from the sterically hindered amine functional curing agent ranges from about 1 percent by weight to about 65 percent by weight of the curable composition.

6. The curable composition of claim 1, further comprising from about 1 percent by weight to about 80 percent by weight of a reinforcing material (f); and wherein the reinforcing material (f) comprises glass fibers.

7. The curable composition of claim 1, further comprising from about 1 percent by weight to about 80 percent by weight of a filler material (g); and wherein the filler (g) comprises calcium carbonate.

8. The curable composition of claim 1, wherein the epoxy resin comprises a cycloaliphatic diepoxide, a diepoxide of divinylbenzene, a diglycidylether of a phenolic or an alcoholic compound, diglycidylether of bisphenol A, or 1,4 butanedioldiglycidylether; or wherein the epoxy resin is made by a peroxidation of an unsaturated compound process; or the reaction product of (i) epihalohydrin and (ii) a phenolic or an alcoholic compound.

9. The curable composition of claim 1, wherein the sterically hindered amine curing agent comprises poly(oxypropylene)diamine; and wherein the non-sterically hindered amine curing agent comprises diethylenetriamine.

10. A process for preparing a curable epoxy resin composition comprising admixing:
(a) at least one or more epoxy resins having an average of more than one glycidyl ether group per molecule;
(b) one or more sterically hindered amine functional curing agents having at least two sterically hindered amine functional groups per molecule; and
(c) one or more non-sterically hindered amine functional curing agents having at least two non-sterically hindered amine functional groups per molecule.

11. A composite or an adhesive comprising a cured resin of the curable composition of claim 1.

12. A process of forming a composite comprising:
(I) admixing:
(a) at least one or more epoxy resins having an average of more than one glycidyl ether group per molecule;
((b) one or more sterically hindered amine functional curing agents having at least two sterically hindered amine functional groups per molecule; and
(c) one or more non-sterically hindered amine functional curing agents having at least two non-sterically hindered amine functional groups per molecule;
(II) impregnating a reinforcement comprised of glass fibers; and
(III) curing the curable composition at a temperature sufficient to cure the curable composition.

13. The process of claim 12, wherein the curing comprises a temperature of at least about 20° C.; and wherein the curing comprises two or more stages.

14. The process of claim 12, further comprising post-treating the composition by heating the composition to a temperature of at least about 70° C.

15. An adhesive, comprising a cured resin of:
(a) at least one or more epoxy resins having an average of more than one glycidyl ether group per molecule;
(b) one or more sterically hindered amine functional curing agents having at least two sterically hindered amine functional groups per molecule; and
(c) one or more non-sterically hindered amine functional curing agents having at least two non-sterically hindered amine functional groups per molecule.
